(19) United States
(12) Patent Application Publication
(10) Pub. No.: US 2016/0208943 A1
(43) Pub. Date: Jul. 21, 2016

(54) GRAVITY FLUID DELIVERY SYSTEM WITH NON-INTRUSIVE CONTROLLER

(71) Applicant: Duane Aiken, Brevard, NC (US)

(72) Inventor: Duane Aiken, Brevard, NC (US)

(21) Appl. No.: 14/980,856

(22) Filed: Dec. 28, 2015

Related U.S. Application Data
(60) Provisional application No. 62/105,836, filed on Jan. 21, 2015.

(51) Int. Cl. F16K 17/36

(52) U.S. Cl. CPC F16K 17/36

(57) ABSTRACT

Systems and methods are provided for delivering fluid by gravity feed, the fluid feed being controlled by motion sensing.

### CROSS-REFERENCE TO RELATED APPLICATIONS

This application claims benefit of U.S. Provisional Patent Application Ser. No. 62/105,836, filed in the United States Patent and Trademark Office on Jan. 21, 2015, which is incorporated herein by reference in its entirety.

### BACKGROUND OF THE DISCLOSURE

Fluid supply systems are used to deliver lubricants during infeeding of material, such as strip metals, to stamping presses and dies. Fluid applicators commonly used with gravity-fed fluid delivery systems are drip, wipers or rollers. Commercially available reservoirs with integral metering valves and solenoid activated shut-off valves are used widely.

The shut-off valve in a fluid supply system is provided to close a supply path from a fluid reservoir without losing an adjustment position of the metering valve(s), which might occur if the metering valve itself is used to shut-off fluid flow. The shut-off valve is operated manually in some primitive setups, which is labor-intensive and prone to error. For instance, if an operator fails to manually turn off the valve during periods of inactivity of a stamping machine, unintentional dispensing may occur. Accordingly, many companies opt for an electrically operated shut-off valve since an electrically operated shut-off valve is connected to the control wiring of the machine shut off occurs automatically when the press stops. However, the electrical shut-off valve option requires intrusion into a control system of the machine, requires a competent electrician to install, and often leads to a permanent installation of the delivery system, all of which increases costs. Moreover, permanent installation may be undesirable.

What is needed in the industry is a fast and easy method of changing lubrication type or concentration for a particular production run without the need for draining and flushing a reservoir and its lines. Additionally, a system is needed that is portable and can be used on multiple stamping machines without the need for maintenance personnel or permanent installation.

### BRIEF SUMMARY OF THE DISCLOSURE

The present disclosure is directed in general to a fluid delivery system having a controller for automatic shut-off. The system detects motion of a ram or other reciprocating motion associated with a machine in operation. Detection is accomplished by a sensing or detection device such as an inductive proximity sensor affixed to a stationary face on a frame of the machine within range of the sensor. Alternatively, a mechanical limit switch may be used for the detection device.

In one aspect, the device is an applicator whereby lubricant is applied to the top and bottom surfaces of metal strips, typically from coil form, as it enters a stamping press or similar. Opposing rollers having a wicking surface, fibrous or otherwise, contact the named surfaces of the strip and roll on their axles by a motion created by the advancement of the strip being powered by its feeding system(s). The rollers are continuously replenished with lubricant, in this case internally, in graduated amounts to control the thickness of the coating.

A signal from the sensing device operates a “One Shot” timing relay to insure that a sustained signal cannot occur should the machine come to rest in a position where the sensor is on. A relay of this sort converts a sustained signal into a single pulse. From this “One Shot” relay, the output signal is fed to a “Delay On Break” timing relay. The operation of a relay of this sort is to “make” instantly once receiving a signal then “break” after an elapsed time period. If the next signal is received before the time expiration, the timer is reset and the relay effectively operates continuously. The output of this relay operates the solenoid valve on the reservoir.

According to another embodiment of the present disclosure, a roller assembly is configured for modular mounting and includes quick change features. The roller assembly may have a base affixable to stamping equipment. A roller applicator may be rapidly removed and replaced with another roller applicator without cleaning or contacting fluid application surfaces.

Another embodiment of the disclosure provides a gravity fluid delivery system, comprising a fluid reservoir; a portable fluid reservoir carrier; a controller; a motion sensor; and means for delivering fluid from the fluid reservoir to a fluid applicator. The fluid reservoir may be made of glass, plastic, metal or combinations of materials resistant to corrosive or abrasive distillates and chemicals. The controller may include a radiofrequency sensor in communication with the motion sensor. The motion sensor may be located near the fluid applicator. The means for delivering fluid from the fluid reservoir to the fluid applicator may be a hose or pipe having an inner tube disposed in an outer tube configured to reduce hose movement if the hose is pressurized.

In a particular embodiment, a gravity lubrication delivery system may include an automatic shut-off valve that is activated by motion of a machine in operation.

In another aspect, a non-intrusive control system that does not require hardwiring to the machine control or other programmable cam switches may be provided.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of a gravity fluid delivery system connected to a roller lubricator system (shown schematically) in an intended use environment according to an aspect of the present disclosure;

FIG. 2 is a perspective view of a gravity fluid delivery system as in FIG. 1;

FIG. 3 is a perspective view of a controller used with the gravity fluid delivery system as in FIG. 1;

FIG. 4 is a perspective view of a gravity fluid delivery system according to another aspect of the disclosure;

FIG. 5 is a perspective view of the gravity fluid delivery system as in FIG. 4 and a partial inset, exploded view showing preparations to remove an empty fluid cylinder from a carrier;

FIG. 6 is a perspective view of the gravity fluid delivery system as in FIG. 5, particularly showing a fluid cylinder removed from the carrier; and

FIG. 7 includes perspective and cross-sectional views (taken along line VII-VII in FIG. 1) of a fluid delivery hose that may be used in a fluid delivery system according to another aspect of the disclosure.

### DETAILED DESCRIPTION OF THE DISCLOSURE

In general, the present disclosure provides systems and methods for improving operations and functionality of applicator devices during treatment of stock metal strips before the stock enters a stamping press or similar production line. The systems are economical to make and use.

Detailed reference will now be made to the drawings in which examples embodying the present subject matter are shown. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. However, the examples set forth in the drawings and detailed descriptions are provided by way of explanation only and are not meant as limitations of the disclosure. The present subject matter thus includes any modifications and variations of the following examples as come within the scope of the appended claims and their equivalents. The detailed description uses numerical and letter designations to refer to features of the drawings.

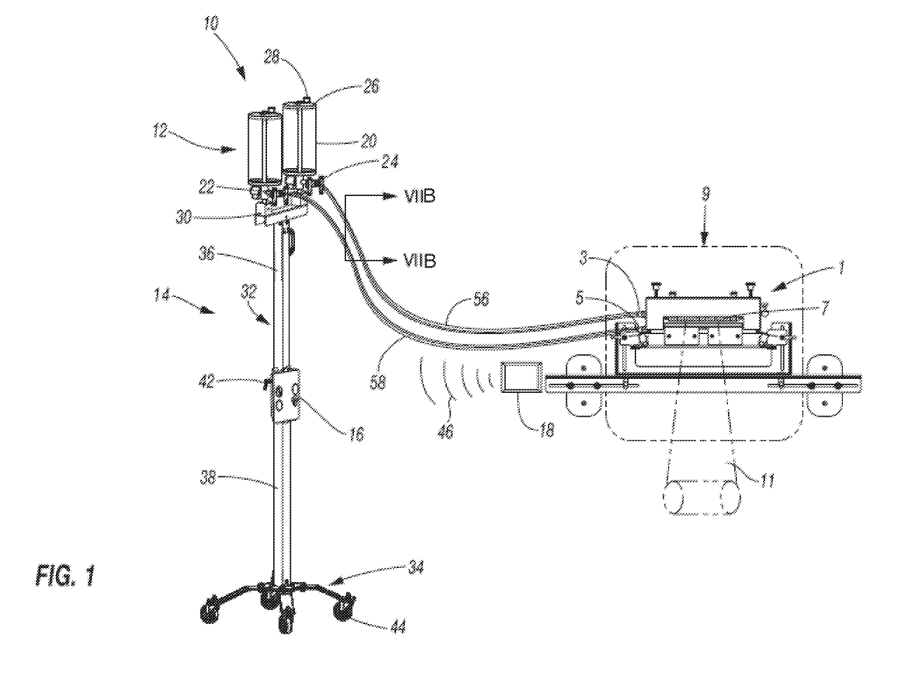

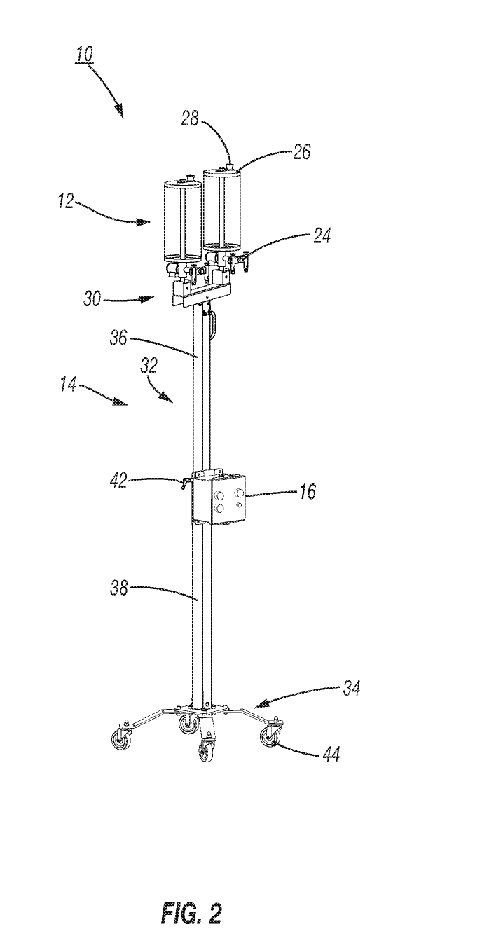

Turning now to the figures, FIGS. 1 and 2 show a gravity fluid delivery system, designated in general by the numeral 10, arranged next to and connected or attached to a roller lubricator system 1, which is operably connected to a press or stamping machine 9 (shown in phantom for clarity). A preferred roller lubricator system 1 is available from Automated Tool and Machine, Inc. of Brevard, N.C., USA. As shown, the exemplary gravity fluid delivery system 10 broadly includes one or more fluid containers or reservoirs 12, a fluid reservoir carrier or portable stand 14, a controller 16, and a proximity or motion sensor and controller 18. As shown, by way of brief introduction, a sheet of material such as stock metal 11 in coil form may be unrolled into the roller lubricator system 1. In this example, two reservoirs 12 of the gravity fluid delivery system 10 deliver a fluid such as a lubricant to rollers 7 in the roller lubricator system 1. The rollers 7 apply a lubrication fluid to a surface of the metal 11, and the metal 11 proceeds downstream in a production line where the lubricated metal 11 is stamped, cut or the like.

With particular reference to the reservoirs 12 shown in FIGS. 1 and 2, each reservoir 12 includes a container 20 that may be a clear material to facilitate visual inspection of fluid inside the container 20. Preferably, the containers 20 are made of clear glass or a non-reactive, impermeable, clear plastic material such as acrylic to withstand various types of chemical lubricants use in metal stamping or pressing processes. Here, the containers 20 each have an attachment or base end 22 with a quick hose connector or discharge valve 24 located at or near the base 22 in this example. A top or filling end 26 of each container 20 may have a quick fill connector 28 to re-fill the container 20 when it becomes empty, as explained below. Moreover, the system 10 could be used on multiple stamping machines 9. Due to the portability of the system 10, it can be repurposed on another machine 9 in a matter of minutes. This procedure can be easily accomplished by a press setter without requiring maintenance personnel or an electrician to permanently install the system 10. The fact that the delivery system 10 is not physically attached to the stamping equipment 9 significantly reduces fluid changeover time for short run productions.

Also shown in FIGS. 1 and 2, the discharge valves 24 of each of the containers 20 is connected to respective fluid hoses 56, 58, such as lubricant hoses available from Automated Tool and Machine, Inc. of Brevard, N.C., USA. The fluid hoses 56, 58 in turn are connected to respective quick connectors 3, 5 of the roller lubricator system 1. Thus, lubricating fluid from the reservoirs 12 is injected into, soaked up by, or permeates the rollers 7, which in turn contact the metal 11 as it passes through the rollers 7.

Also shown in the example in FIG. 1, the fluid reservoir carrier 14 includes a reservoir end 30, a telescoping body or frame 32, and a roller base 34. The reservoir end 30 is configured to receive and seat the base end 22 of the container 20 introduced above. Here, the telescoping body 32 has a first, top or distal end 36 and a second, bottom, or proximal end 38, which has a generally larger inner circumference or perimeter than an outer circumference or perimeter of the top end 36. A control latch or handle 42 is used to recess a portion of the top end 36 into a portion of the bottom end 38, as explained in greater detail below. Also in this example, the roller base 34 may include a plurality of wheels 44 to move or maneuver the gravity fluid delivery system 10 to a desired position.

FIG. 1 further shows the motion sensor 18 arranged at or near the stamping machine 9. The motion sensor 18 detects the motion of a ram or other reciprocating motion associated with the machine 9 while in operation. The motion sensing and detecting, indicated by electromagnetic waves or rays 46, is accomplished by affixing or positioning the sensor 18 to a stationary face, for example, on a frame of the machine 9 within range of the sensor 18. Here, the sensor 18 is an inductive proximity sensor but other sensors such as a mechanical limit switch may be used as the detection device 18. As shown, the motion sensing and detecting 46 is relayed to the controller 16.

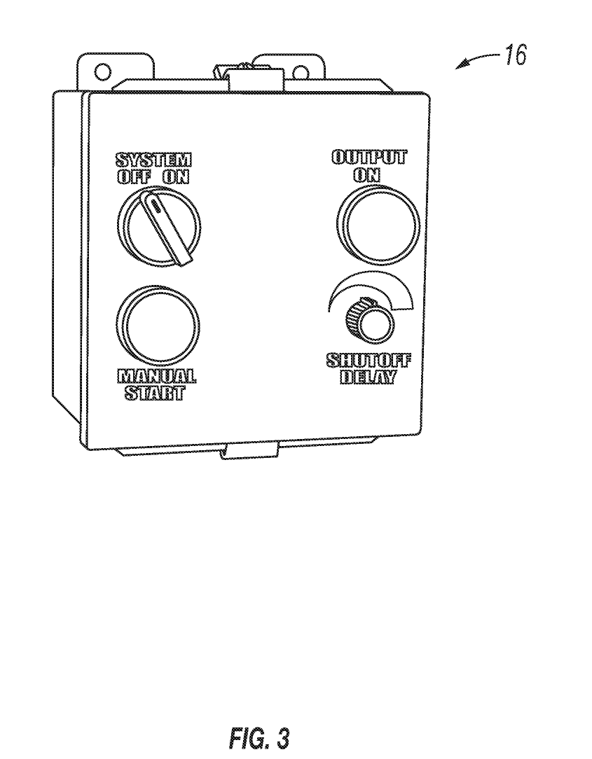

FIGS. 2 and 3 more clearly show the controller 16. Once the controller 16 is turned on, a signal from the sensing device 18 will automatically operate a “one shot” timing relay to insure that a sustained signal cannot occur should the machine 9 come to rest in a position where the sensor 18 is on. A relay of this sort converts a sustained signal into a single pulse. From this “one shot” relay, the output signal is fed to a “Delay On Break” timing relay. The operation of such a relay of this sort is to “make” instantly once receiving a signal then “break” after an elapsed time period. If the next signal is received before the time expiration, the timer is reset and the relay effectively operates continuously. The output of this relay operates the solenoid valve on the reservoir 18 to shut off the reservoir 18.

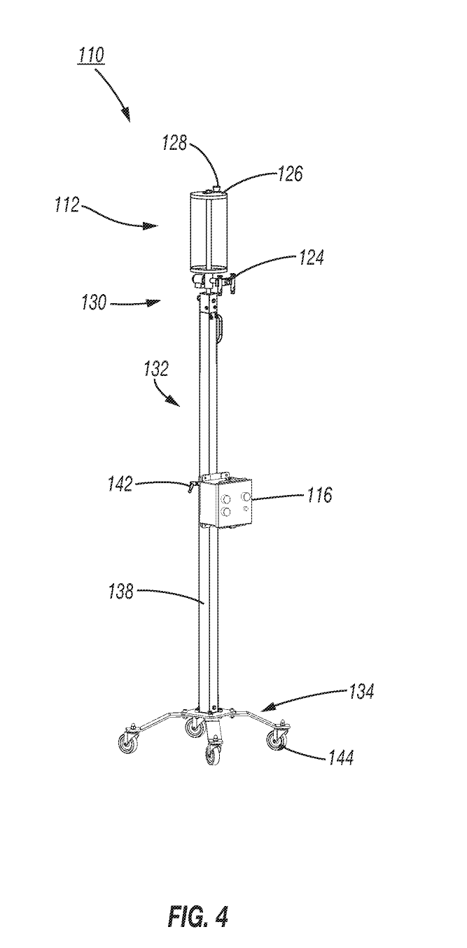

FIG. 4 shows a gravity fluid delivery system designated in general by the numeral 110 according to another aspect of the disclosure. The gravity fluid delivery system 110 broadly includes a fluid container or reservoir 112, a fluid reservoir carrier or portable stand 114, a controller 116, and a proximity or motion sensor and controller 118. In this example, the reservoir 112 of the gravity fluid delivery system 110 is designed to hold and deliver a fluid such as a lubricant to a lubricator system to apply a lubrication fluid to a surface of a metal for stamping, cutting or the like.

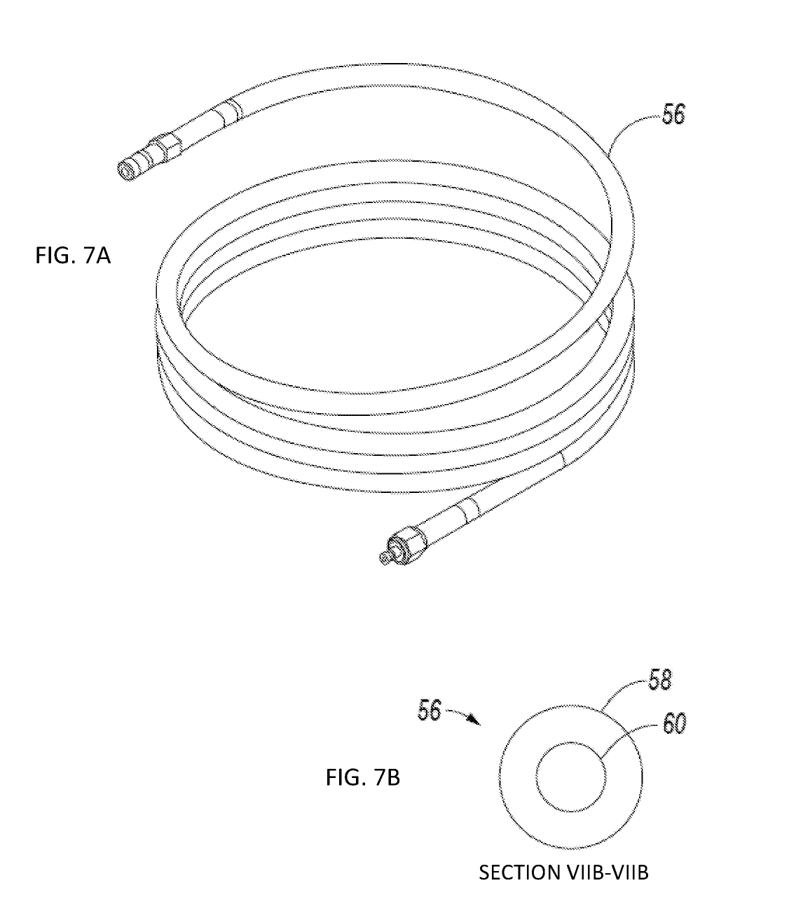

The reservoir 112 shown in FIG. 4 includes a container 120 that may be a clear material to facilitate visual inspection of fluid inside the container 120. Preferably, the container 120 is made of clear glass or a non-reactive, impermeable material to withstand various types of chemical lubricants use in metal stamping or pressing processes. As FIG. 4 further shows, the container 120 has an attachment or base end 122 with a quick hose connector or discharge valve 124 located at or near the base 122. A top or filling end 126 of the container 120 may have a quick fill connector 128 to re-fill the container 120 when it becomes empty, as explained below. The discharge valve 124 of the container 120 is connected to a fluid hose such as a Kickless™ lubricant hose available from Automated Tool and Machine, Inc. of Brevard, N.C., USA, as shown for example in FIG. 7. The fluid hose in turn will be connected to a lubricator system to prepare a material such as metal for stamping, cutting or pressing.

Also shown in the example in FIG. 4, the fluid reservoir carrier 114 includes a reservoir end 130, a telescoping body or frame 132, and a roller base 134. The reservoir end 130 is configured to receive and seat the base end 122 of the container 120 noted above. The telescoping body 132 has a first, top or distal end 136 and a second, bottom, or proximal end 138 having a generally larger inner circumference or perimeter than an outer circumference or perimeter of the top end 136. A control latch or handle 142 is used to recess a portion of the top end 136 into a portion of the bottom end 138, as explained in greater detail below. The roller base 134 may include a plurality of wheels 144 to move or maneuver the gravity fluid delivery system 110 to a required position.

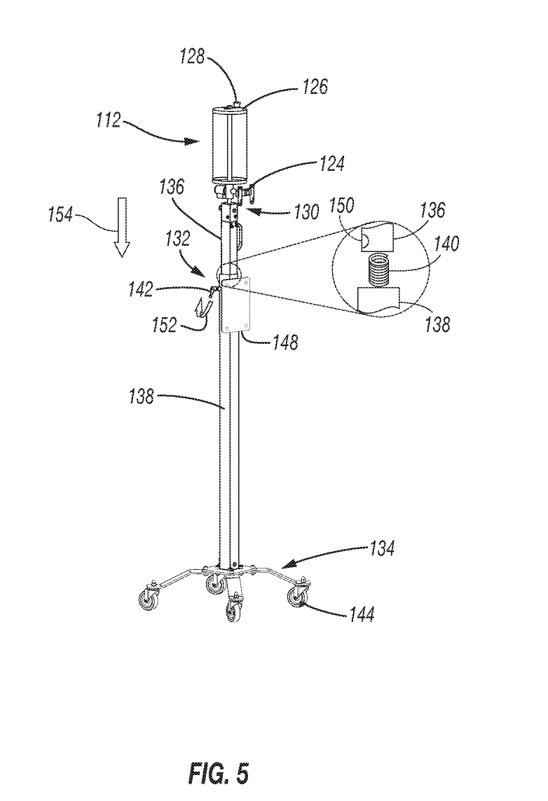

FIG. 5 shows by way of example operation an empty reservoir 112 being readied for removal and replacement or refilling. Here, the release latch or control handle 142 is rotated in a release direction 152 to lower the first end 136 into the second end 138 as indicated by the direction arrow 154. More particularly, as shown exploded in an inset view, a gas spring or conventional spring 140 is arranged within and between the first and second ends 136, 138. This arrangement permits the empty reservoir 112 to be lowered to a workable height, for instance, to avoid fluid spills by having to stand on a ladder to refill the container 120. Once the desired refill height or first state is reached, the latch 142 can be returned to a locking position and lock into a notch or keyhole 150, for instance, to hold the compressed assembly in the first state during refilling. Once the reservoir 112 is refilled or replaced, the control handle 142 is rotated by reversing the direction 152 urging the spring 140 to cause the first end 136 to return to an extended position or second state. Those skilled in the art will appreciate that other forms of unlocking and adjusting the telescoping parts 136, 138 relative to each other can be practiced and are within the scope of equivalents of the disclosure.

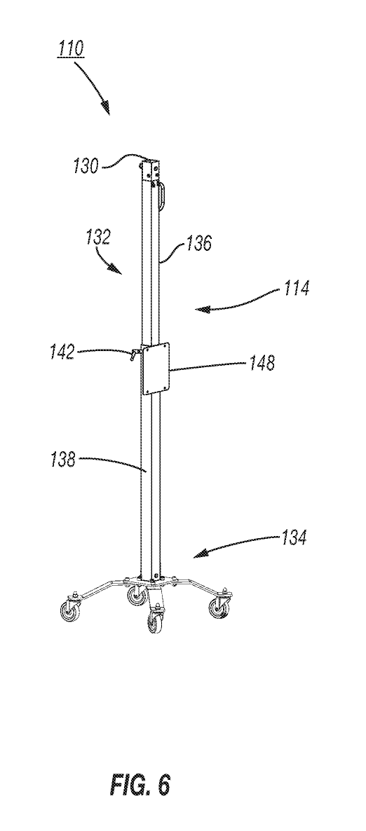

Turning to FIG. 6, the fluid reservoir carrier 114 with the reservoir end 130, the frame 132, and the roller base 134 is shown with the reservoir 112 and the controller 116 removed from an exemplary holding or attachment plate 148 (compare FIG. 4). This may be desired when the lubrication type or concentration needs to be changed for a particular production run. Accordingly, the reservoir 112 can simply be removed without needing to drain and flush the reservoir 112 and associated fluid lines. Additionally, a user could simply disconnect fluid supply lines from a fluid applicator, roll the delivery system 110 aside and replace it with another having a reservoir 112 filled with the desired lubricant. Here, the handle 142 is shown returned to an unlocked, normal or relaxed position and the first arm 136 has extended from the second arm 138 of the frame 132.

FIG. 7 shows an exemplary fluid delivery hose assembly 56. Also shown in cross section from FIG. 1, the hose assembly 56 includes an outer tube 58 and an inner composite tube 60 with rigid walls. In this example, the inner composite tube 60 is approximately ⅛ inch in diameter; however, such a tube alone would weigh relatively little and would move more if pressure were applied. Tube movement may damage a hose and cause leaks and increase the risk of harm to personnel if the tube moves into a walkway. Stated another way, as diameter decreases in order to achieve a better dispense, pressure rating increases, and there is more tube movement. Therefore, the outer tube 58 surrounds the necessarily smaller inner tube 60 to reduce movement or flopping and to achieve a better or more precise fluid dispense if a system is augmented by pressurization.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A gravity fluid delivery system, comprising:
a fluid reservoir;
a portable fluid reservoir carrier;
a controller;
a motion sensor; and
means for delivering fluid from the fluid reservoir to a fluid applicator.

2. The gravity fluid delivery system as in claim 1, wherein the fluid reservoir is made of a material selected from the group consisting of glass, plastic, metal and combinations thereof.

3. The gravity fluid delivery system as in claim 1, wherein the portable fluid reservoir carrier includes wheels.

4. The gravity fluid delivery system as in claim 1, wherein the controller includes a sensor in communication with the motion sensor.

5. The gravity fluid delivery system as in claim 1, wherein the motion sensor is disposed proximate the fluid applicator.

6. The gravity fluid delivery system as in claim 1, wherein the means for delivering fluid from the fluid reservoir to the fluid applicator is a hose having an inner tube disposed in an outer tube configured to reduce hose movement when the hose is pressurized.

7. A gravity fluid delivery system, comprising:
a fluid reservoir;
a fluid reservoir carrier;
a controller;
an inductive proximity or electromagnetic sensor disposed proximate a fluid applicator on a stamping line, the sensor being configured to sense motion in the stamping line; and
a pressure-responsive hose for delivering fluid from the fluid reservoir to a fluid applicator, the sensor in communication with the controller to deliver fluid from the fluid reservoir based on the sensed motion.

8. The gravity fluid delivery system as in claim 7, wherein the fluid reservoir is made from a corrosive-resistant material.

9. The gravity fluid delivery system as in claim 7, wherein the pressure-responsive hose includes a first tube disposed within a second tube and configured to reduce hose movement when the pressure-responsive hose is pressurized.

10. A gravity fluid delivery system, comprising:
a fluid reservoir;
a portable fluid reservoir carrier, the fluid reservoir attached thereto;
a controller in wireless communication with a stamping line;
a motion sensor disposed proximate the stamping line;
a shut-off valve; and
a pressure-sensitive conduit for delivering fluid from the fluid reservoir to a fluid applicator attached to the stamping line.

11. The gravity lubrication delivery system in claim 10, wherein the shut-off valve is activated by motion of the stamping line.
